(19) United States
(12) Patent Application Publication
(10) Pub. No.: US 2011/0292192 A1
(43) Pub. Date: Dec. 1, 2011

(54) STEREOSCOPIC DISPLAY DEVICE, DISPLAY CONTROL CIRCUIT, AND DISPLAY METHOD

(75) Inventor: Tomoyuki Murakami, Saitama (JP)

(73) Assignee: SONY CORPORATION, Tokyo (JP)

(21) Appl. No.: 13/114,650

(22) Filed: May 24, 2011

(30) Foreign Application Priority Data
May 31, 2010 (JP) P2010-124311

(51) Int. Cl. G02B 27/22; H04N 13/04

(52) U.S. Cl. 348/56; 359/464; 348/E13.075

(57) ABSTRACT

A display method includes: time-divisionally displaying a plurality of stereoscopic vision images corresponding to a plurality of perspectives, through time-divisionally displaying a left-eye image and a right-eye image configuring each of the plurality of stereoscopic vision images corresponding to the respective perspectives; detecting an azimuth or respective azimuths in which one or more shutter eyeglasses are located, in which the shutter eyeglasses including a left-eye shutter and a right-eye shutter; and allowing the left-eye shutter and the right-eye shutter in one or more shutter eyeglasses located in the azimuth corresponding to the perspective of the stereoscopic vision image currently displayed to be open and closed, based on a detection result thereof, and in synchronization with a left-eye-image display timing and a left-eye-image display timing for each of the stereoscopic vision images corresponding to the respective perspectives.

### CROSS-REFERENCE TO RELATED APPLICATION

The present application claims priority from Japanese Patent Application No. JP 2010-124311 filed in the Japanese Patent Office on May 31, 2010, the entire content of which is incorporated herein by reference.

### BACKGROUND OF THE INVENTION

This disclosure relates to a display device capable of performing stereoscopic vision displaying, and to a display control circuit and to a display method each of which is used for the display device.

In recent years, attention has been drawn to a display device capable of realizing stereoscopic vision displaying. The stereoscopic vision displaying displays a stereoscopic vision image including a left-eye image and a right-eye image that have parallax with respect to each other (i.e., a parallax image). The stereoscopic vision displaying makes it possible for an observer to recognize the left-eye image and the right-eye image as a stereoscopic image having a depth, by allowing the observer to see the left-eye image and the right-eye image with his/her left and right eyes, respectively.

Some of those display devices are capable of displaying stereoscopic vision images having different perspectives one another in accordance with a position of the perspective of the observer, when a relative positional relationship between the display device and the observer is changed. For example, Japanese Patent Application Unexamined Publication No. 2008-146221 (JP2008-146221A) discloses a display device provided with image-capturing cameras and configured to obtain, based on captured images of the image-capturing cameras, a current position of a perspective of an observer, to generate on a real-time basis a parallax image that corresponds to the current position of the perspective of the observer and display the thus-generated parallax image. In this display device, the parallax image changes in accordance with that perspective when the perspective of the observer is moved in observing the display device, thus allowing the observer to recognize the displayed image as an image which is more stereoscopic.

### SUMMARY OF THE INVENTION

It is desirable that an electronic unit be simple in operation in terms of factors such as a circuit size, performance desired in a circuit, and a power consumption. The display device disclosed in JP2008-146221A has room for improvement, in that the display device of JP2008-146221A generates a parallax image in accordance with a current position of a perspective of an observer on a real-time basis, so that a process operation may be complex and a processing load may be increased.

Also, in general applications of a display device, a plurality of observers see a displayed image at the same time. However, JP2008-146221A is silent as to a case where there are plurality of observers.

It is desirable to provide a stereoscopic display device, a display control circuit, and a display method, capable of displaying a stereoscopic vision image that corresponds to a position of a perspective of one or more observers with a simple configuration.

A stereoscopic display device according to an embodiment of the technology includes: a display section; a detecting section detecting an azimuth or respective azimuths in which one or more shutter eyeglasses are located, the shutter eyeglasses including a left-eye shutter and a right-eye shutter; a display controlling section time-divisionally displaying, on the display section, a plurality of stereoscopic vision images corresponding to a plurality of perspectives, through time-divisionally displaying, on the display section, a left-eye image and a right-eye image configuring each of the plurality of stereoscopic vision images corresponding to the respective perspectives; and a shutter controlling section allowing the left-eye shutter and the right-eye shutter in one or more shutter eyeglasses located in the azimuth corresponding to the perspective of the stereoscopic vision image currently displayed on the display section to be open and closed, based on a detection result from the detecting section, and in synchronization with a left-eye-image display timing on the display section and a left-eye-image display timing on the display section for each of the stereoscopic vision images corresponding to the respective perspectives.

A display control circuit according to an embodiment of the technology includes: a detecting section detecting an azimuth or respective azimuths in which one or more shutter eyeglasses are located, in which the shutter eyeglasses including a left-eye shutter and a right-eye shutter; a display controlling section time-divisionally displaying, on a display section, a plurality of stereoscopic vision images corresponding to a plurality of perspectives, through time-divisionally displaying, on the display section, a left-eye image and a right-eye image configuring each of the plurality of stereoscopic vision images corresponding to the respective perspectives; and a shutter controlling section allowing the left-eye shutter and the right-eye shutter in one or more shutter eyeglasses located in the azimuth corresponding to the perspective of the stereoscopic vision image currently displayed on the display section to be open and closed, based on a detection result from the detecting section, and in synchronization with a left-eye-image display timing on the display section and a left-eye-image display timing on the display section for each of the stereoscopic vision images corresponding to the respective perspectives.

A display method according to an embodiment of the technology includes: time-divisionally displaying a plurality of stereoscopic vision images corresponding to a plurality of perspectives, through time-divisionally displaying a left-eye image and a right-eye image configuring each of the plurality of stereoscopic vision images corresponding to the respective perspectives; detecting an azimuth or respective azimuths in which one or more shutter eyeglasses are located, the shutter eyeglasses including a left-eye shutter and a right-eye shutter; and allowing the left-eye shutter and the right-eye shutter in one or more shutter eyeglasses located in the azimuth corresponding to the perspective of the stereoscopic vision image currently displayed to be open and closed, based on a detection result thereof, and in synchronization with a left-eye-image display timing and a left-eye-image display timing for each of the stereoscopic vision images corresponding to the respective perspectives.

In the stereoscopic display device, the display control circuit, and the display method according to the embodiments of the technology, the shutter eyeglasses are controlled to be open or closed in synchronization with the stereoscopic vision images, corresponding to the plurality of perspectives, that are displayed on the display section. Here, the shutter eyeglasses are controlled, based on the azimuth detected by the detecting section, to be open or closed for the stereoscopic vision image corresponding to that azimuth.

Advantageously, the stereoscopic display device further includes an image generating section generating the stereoscopic vision images corresponding to the plurality of perspectives.

Advantageously, the detecting section establishes a plurality of perspective azimuth zones which center the display section, and determines one perspective azimuth zone, to which each of the shutter eyeglasses belongs, from the plurality of perspective azimuth zones.

Advantageously, the stereoscopic vision images corresponding to the plurality of perspectives correspond to the plurality of perspective azimuth zones, respectively.

Advantageously, the stereoscopic display device further includes an image generating section generating the stereoscopic vision images corresponding to the plurality of perspectives.

Advantageously, the stereoscopic display device further includes a decoder reconstructing, based on supplied image frames, a plurality of parallax images, and the image generating section generates, based on the plurality of parallax images reconstructed, the stereoscopic vision images corresponding to the plurality of perspectives.

Advantageously, the plurality of parallax images forming one scene are treated to configure one image frame.

This embodiment may correspond to a scheme such as a so-called side-by-side scheme and an over-under scheme.

Advantageously, each of the plurality of parallax images forming one scene is treated to configure one image frame. This embodiment may correspond to a so-called frame-packing scheme.

Advantageously, the plurality of parallax images forming one scene are divided into a plurality of groups, and the parallax images included in each of the groups are treated to configure one image frame. This embodiment may correspond to a combined scheme such as a combination of the side-by-side scheme and the frame-packing scheme and a combination of the over-under scheme and the frame-packing scheme.

Advantageously, the detecting section includes an image-capturing section, and detects, based on an image captured by the image-capturing section, the azimuth or the respective azimuths in which one or more shutter eyeglasses are located.

Advantageously, the detecting section recognizes the shutter eyeglasses based on a feature point which is provided to the shutter eyeglasses.

Advantageously, the image generating section generates the stereoscopic vision images corresponding to the plurality of perspectives to allow a common parallax image to be included in a couple of stereoscopic vision images corresponding to a couple of adjacent perspectives.

Advantageously, while the common parallax image is on display, the shutter controlling section allows the left-eye shutter of the shutter eyeglasses belonging to a first perspective azimuth zone to be open and allows the right-eye shutter thereof to be closed, whereas allows the left-eye shutter of the shutter eyeglasses belonging to a second perspective azimuth zone to be closed and allows the right-eye shutter thereof to be open, the first and second perspective azimuth zones being adjacent to each other.

According to the stereoscopic display device, the display control circuit, and the display method of the embodiments of the technology, the stereoscopic vision images corresponding to the plurality of perspectives are displayed on the display section, and the shutters are controlled to be open and closed in accordance with the azimuth or the azimuths of the shutter eyeglasses. Therefore, it is possible to display the stereoscopic vision image that corresponds to a position of a perspective of one or more observers with a simple configuration.

Also, it is possible to display the stereoscopic vision images that correspond to the positions of the perspectives of the respective observers when the plurality of shutter eyeglasses are used.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating an example of a configuration of a display device according to a first embodiment of the technology.

FIG. 2 schematically illustrates an example of a configuration of parallax images according to the first embodiment.

FIGS. 3A and 3B each schematically illustrate an example of a picture signal according to the first embodiment.

FIGS. 4A and 4B each schematically illustrate an example of an operation of a stereoscopic vision image generating section according to the first embodiment.

FIGS. 5A and 5B each schematically illustrate an example of an operation of a position detecting section according to the first embodiment.

FIGS. 6A to 6D each schematically illustrate an example of an operation of a display system according to the first embodiment.

FIGS. 7A to 7C each schematically illustrate an example of an operation of the display device according to the first embodiment.

FIGS. 8A to 8F each schematically illustrate another example of the operation of the display system according to the first embodiment.

FIGS. 9A to 9C each schematically illustrate another example of the operation of the display device according to the first embodiment.

FIGS. 10A to 10F each schematically illustrate yet another example of the operation of the display system according to the first embodiment.

FIG. 11 schematically illustrates an example of an operation of a stereoscopic vision image generating section according to a second embodiment of the technology.

FIGS. 12A to 12D each schematically illustrate an example of an operation of a display system according to the second embodiment.

FIGS. 13A to 13C each schematically illustrate an example of an operation of a display device according to the second embodiment.

### DETAILED DESCRIPTION

In the following, some embodiments of the technology will be described in detail with reference to the accompanying drawings. The description will be given in the following order.
1. First Embodiment
2. Second Embodiment
(1. First Embodiment)
(Configuration Example)
(Overall Configuration)

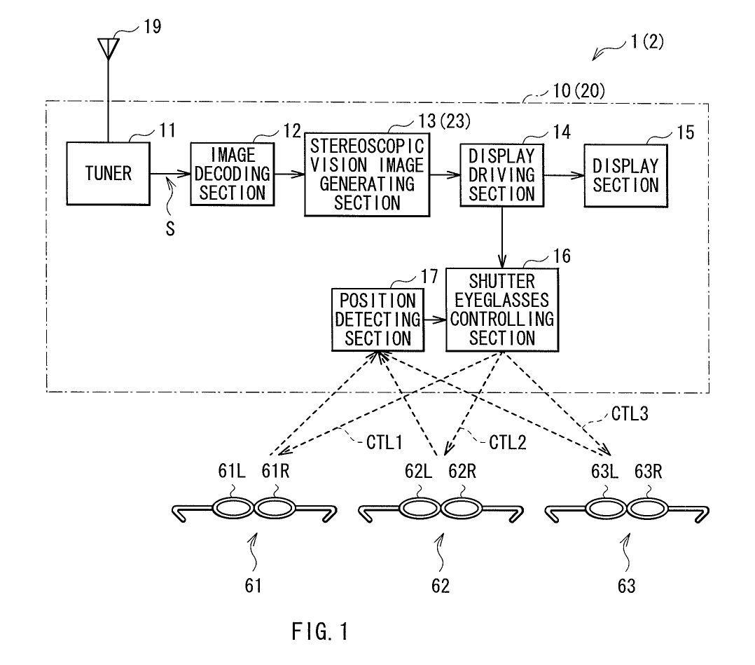

FIG. 1 illustrates a configuration example of a display system 1 according to a first embodiment of the technology. It is to be noted that this embodiment is applicable to and embodies a display control circuit and a display method according to embodiments of the technology. Hence, description on the display control circuit and the display method will be given collectively in conjunction with the embodiments. The display system 1 is capable of performing stereoscopic vision displaying, and displays a stereoscopic vision image corresponding to a position of an observer. Also, the display system 1 is capable of displaying the stereoscopic vision images corresponding to the positions of respective observers even when there are plurality of observers. In the following, description will be given with reference to the display system covering three observers as an example. The display system 1 is provided with a display device 10, and shutter eyeglasses 61 to 63.

The display device 10 includes a tuner 11, an image decoding section 12, a stereoscopic vision image generating section 13, a display driving section 14, a display section 15, a shutter eyeglasses controlling section 16, and a position detecting section 17.

The tuner 11 performs a process such as a predetermined receiving process on a broadcast wave received by an antenna 19 to thereby restore and generate signals such as a picture signal S and an audio signal. The tuner 11 then supplies the picture signal S to the image decoding section 12. In this embodiment, the picture signal S includes four parallax images A to D (described later), although it is not limited thereto. The picture signal S may be a signal encoded by and transmitted from unillustrated devices in a broadcast station.

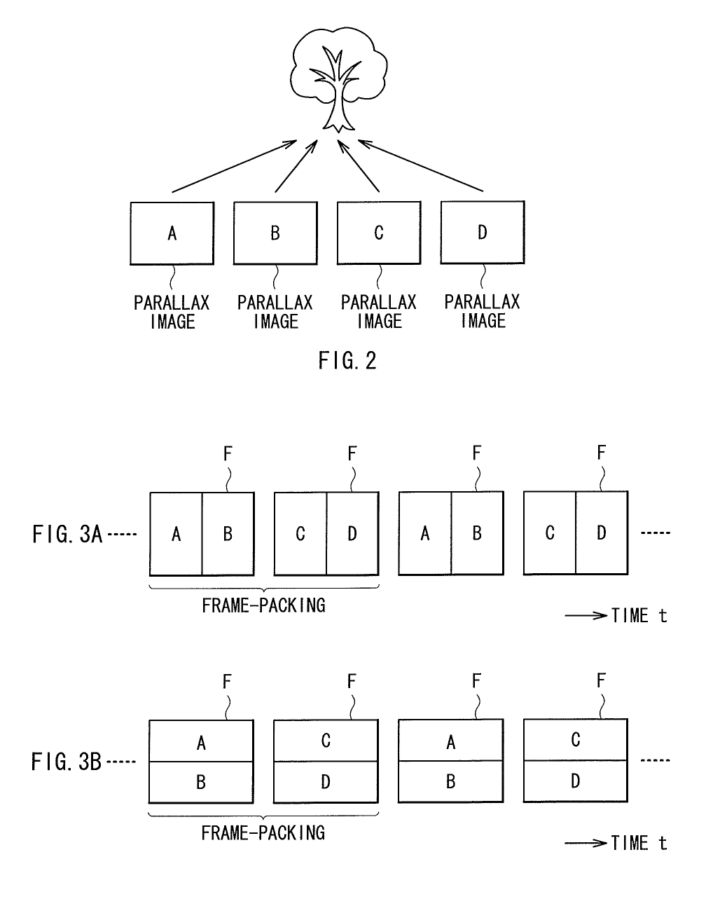

FIG. 2 illustrates the parallax images A to D. The parallax images A to D are images obtained by viewing an object from mutually-different directions. Namely, the parallax images A to D are images having parallax with respect to each other. In this embodiment, the parallax images A to D are in order of images that are obtained by viewing the object from a left side to a right side of the object, although they are not limited thereto. For example, the parallax image A is the image obtained by viewing the object from the left side of the object, and the parallax image D is the image obtained by viewing the object from the right side of the object.

FIGS. 3A and 3B each schematically illustrate a configuration of the picture signal S, wherein FIG. 3A illustrates one example of the configuration thereof, whereas FIG. 3B illustrates another example. The picture signal S may be encoded by a method in which a side-by-side scheme, an over-under scheme, and a frame-packing scheme are combined. The side-by-side scheme, the over-under scheme, and the frame-packing scheme are those that have been proposed respectively as a format (3D format) of a stereoscopic image configured of a left-eye image and a right-eye image having parallax with respect to each other. The side-by-side scheme disposes, for example, the left-eye image on the left side of a frame and disposes the right-eye image on the right side of the frame, to thereby treat a set of left-eye and right-eye images as one image (one frame). The over-under scheme disposes, for example, the left-eye image on the upper side of a frame and disposes the right-eye image on the lower side of the frame, to thereby treat a set of left-eye and right-eye images as one image (one frame). The frame-packing scheme disposes, for example, the left-eye image in a first frame and disposes the right-eye image in a second frame, to thereby treat the first and the second frames as a set.

The picture signal S illustrated in FIG. 3A is a picture signal encoded by combining the side-by-side and the frame-packing schemes. Namely, two parallax images A and B and two parallax images C and D among the four parallax images A to D are respectively arranged in one frame F by the side-by-side scheme, and those two frames F are treated as a set by the frame-packing scheme.

The picture signal S illustrated in FIG. 3B is a picture signal encoded by combining the over-under and the frame-packing schemes. Namely, two parallax images A and B and two parallax images C and D among the four parallax images A to D are respectively arranged in one frame F by the over-under scheme, and those two frames F are treated as a set by the frame-packing scheme.

The picture signal S, in addition to image information corresponding to the four parallax images A to D described above, includes additional information on an order of the parallax images A to D, such as the order illustrated in FIG. 2. This additional information makes it possible for the image decoding section 12 (described later) to reconstruct and generate the four parallax images A to D in that order.

The image decoding section 12 decodes the picture signal S supplied from the tuner 11. More specifically, the image decoding section 12 has functions of decoding the picture signal S, such as that illustrated in FIG. 3A and that illustrated in FIG. 3B, and reconstructing and generating each of the four parallax images A to D as a single image.

The stereoscopic vision image generating section 13 generates, based on the four parallax images A to D supplied from the image decoding section 12, a plurality of stereoscopic vision images each having a pair of left-eye image and right-eye image. The stereoscopic vision image generating section 13 generates, based on the determined number of perspectives, the stereoscopic vision images corresponding to that number of perspectives. For example, when the number of perspectives is set to two perspectives, the stereoscopic vision image generating section 13 generates stereoscopic vision images P1 and P2 (described later) corresponding to the two perspectives. When the number of perspectives is set to three perspectives, the stereoscopic vision image generating section 13 generates stereoscopic vision images Q1 to Q3 (described later) corresponding to the three perspectives.

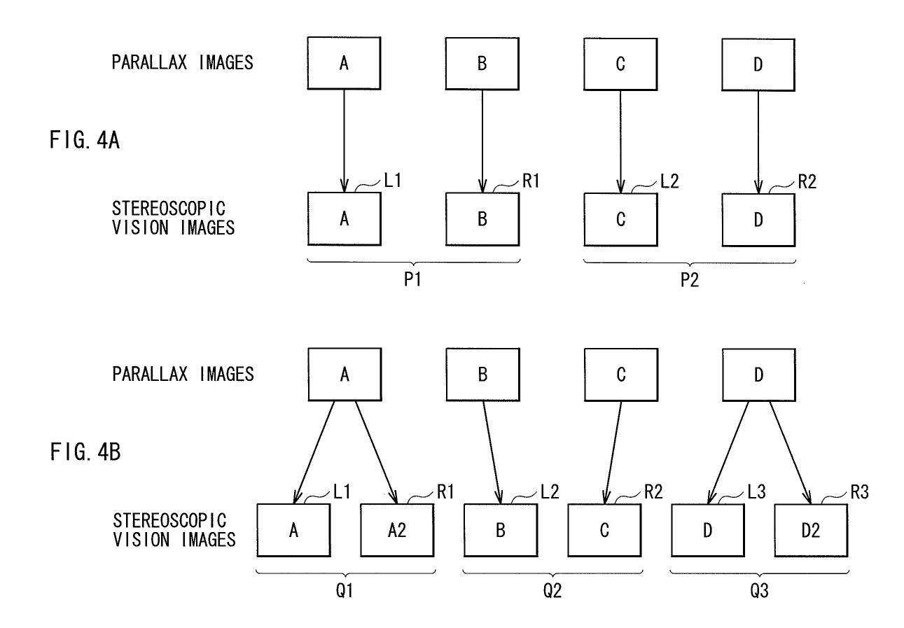

FIGS. 4A and 4B each schematically illustrate an operation of the stereoscopic vision image generating section 13, wherein FIG. 4A illustrates an example where the number of perspectives is two, and FIG. 4B illustrates an example where the number of perspectives is three.

In the example of the two perspectives as illustrated in FIG. 4A, the stereoscopic vision image generating section 13 generates, based on the parallax images A and B, the stereoscopic vision image P1 (a left-eye image L1 and a right-eye image R1), and generates, based on the parallax images C and D, the stereoscopic vision image P2 (a left-eye image L2 and a right-eye image R2). More specifically, in generating the stereoscopic vision image P1, the stereoscopic vision image generating section 13 uses the parallax image A directly or “as it is” to generate the left-eye image L1, and uses the parallax image B directly or “as it is” to generate the right-eye image R1. In generating the stereoscopic vision image P2, the stereoscopic vision image generating section 13 uses the parallax image C directly or “as it is” to generate the left-eye image L2, and uses the parallax image D directly or “as it is” to generate the right-eye image R2.

Thereby, the stereoscopic vision image P1 serves as an image when viewing the object from the perspective on the left side of the object, and the stereoscopic vision image P2 serves as an image when viewing the object from the perspective on the right side of the object.

In the example of the three perspectives as illustrated in FIG. 4B, the stereoscopic vision image generating section 13 generates, based on the parallax image A, the stereoscopic vision image Q1 (the left-eye image L1 and the right-eye image R1), generates, based on the parallax images B and C, the stereoscopic vision image Q2 (the left-eye image L2 and the right-eye image R2), and generates, based on the parallax image D, the stereoscopic vision image Q3 (a left-eye image L3 and a right-eye image R3). More specifically, in generating the stereoscopic vision image Q1, the stereoscopic vision image generating section 13 uses the parallax image A directly or “as it is” to generate the left-eye image L1, and applies a predetermined parallax generating process to the parallax image A to thereby generate a parallax image A2, and uses the thus-generated parallax image A2 to generate the right-eye image R1. In generating the stereoscopic vision image Q2, the stereoscopic vision image generating section 13 uses the parallax image B directly or “as it is” to generate the left-eye image L2, and uses the parallax image C directly or “as it is” to generate the right-eye image R2. Further, in generating the stereoscopic vision image Q3, the stereoscopic vision image generating section 13 uses the parallax image D directly or “as it is” to generate the left-eye image L3, and applies a predetermined parallax generating process to the parallax image D to thereby generate a parallax image D2, and uses the thus-generated parallax image D2 to generate the right-eye image R3.

Thereby, the stereoscopic vision image Q1 serves as an image when viewing the object from the perspective on the left side of the object, the stereoscopic vision image Q2 serves as an image when viewing the object from the front perspective, and the stereoscopic vision image Q3 serves as an image when viewing the object from the perspective on the right side of the object.

In this embodiment, each of the parallax images A to D is used, in the stereoscopic vision image generating section 13, for generating a single stereoscopic vision image. Namely, in the example of the two perspectives, each of the parallax images A and B is used only for generating the stereoscopic vision image P1, and each of the parallax images C and D is used only for generating the stereoscopic vision image P2. In the example of the three perspectives, the parallax image A is used only for generating the stereoscopic vision image Q1, each of the parallax images B and C is used only for generating the stereoscopic vision image Q2, and the parallax image D is used only for generating the stereoscopic vision image Q3.

The display driving section 14 drives, based on a signal which includes the stereoscopic vision images corresponding to the plural number of perspectives that are supplied from the stereoscopic vision image generating section (i.e., the stereoscopic vision images P1 and P2 when the number of perspectives is two, and the stereoscopic vision images Q1 to Q3 when the number of perspectives is three), the display section 15, and supplies a control signal to the shutter eyeglasses controlling section 16 so that the shutter eyeglasses 61 to 63 each operate in synchronization with the stereoscopic vision image displayed on the display section 15.

The display section 15 displays, based on a drive signal supplied from the display driving section 14, the stereoscopic vision images corresponding to the plural number of perspectives. More specifically, when the number of perspectives is two, the display section 15 alternately displays the left-eye image L1 and the right-eye image R1 of the stereoscopic vision image P1 and alternately displays the left-eye image L2 and the right-eye image R2 of the stereoscopic vision image P2 in a time-divisional fashion, as will be described later in detail. When the number of perspectives is three, the display section 15 alternately displays the left-eye image L1 and the right-eye image R1 of the stereoscopic vision image Q1, alternately displays the left-eye image L2 and the right-eye image R2 of the stereoscopic vision image Q2, and alternately displays the left-eye image L3 and the right-eye image R3 of the stereoscopic vision image Q3 in a time-divisional fashion, as will be described later in detail.

The shutter eyeglasses controlling section 16 controls, based on the control signal supplied from the display driving section 14 and that supplied from the position detecting section 17, the shutter eyeglasses 61 to 63. More specifically, the shutter eyeglasses controlling section 16 has functions of sending shutter control signals CTL1 to CTL3 to the shutter eyeglasses 61 to 63, to thereby so control the shutter eyeglasses 61 to 63 as to allow left-eye shutters 61L to 63L (described later) and right-eye shutters 61R to 63R (described later) of the shutter eyeglasses 61 to 63 to be open and closed in synchronization with each of the stereoscopic vision images corresponding to the plural number of perspectives that is displayed on the display section 15.

The shutter eyeglasses 61 to 63 are shutter devices of eyeglasses-type worn by observers. The shutter eyeglasses have the left-eye shutter 61L and the right-eye shutter 61R. The shutter eyeglasses 62 have the left-eye shutter 62L and the right-eye shutter 62R. The shutter eyeglasses 63 have the left-eye shutter 63L and the right-eye shutter 63R. The left-eye shutters 61L to 63L and the right-eye shutters 61R to 63R are each configured by a light-shielding shutter such as a liquid crystal shutter, for example. Light-shield states (an open state and a closed state) of the left-eye shutters 61L to 63L and the right-eye shutters 61R to 63R are controlled by the shutter control signals CTL1 to CTL3. Also, the shutter eyeglasses 61 to 63 each have a feature factor such as a characteristic color, pattern, and shape (i.e., a feature point), for example. For example, the shutter eyeglasses 61 to 63 each may have a characteristic frame shape. As will be described later, this thereby makes it possible for the position detecting section 17 to recognize the shutter eyeglasses 61 to 63 from an image that has captured the shutter eyeglasses 61 to 63, and to figure out or identify positions of those shutter eyeglasses 61 to 63.

The position detecting section 17 detects relative positional relationships between the display section 15 and the shutter eyeglasses 61 to 63. For example, the position detecting section 17 may include a camera (an image-capturing section), and may be configured to recognize, based on the image in which the shutter eyeglasses 61 to 63 and the observers are captured by the camera, the shutter eyeglasses 61 to 63, and to thereby detect the relative positional relationships between the display section 15 and the shutter eyeglasses 61 to 63. It is to be noted that a scheme of recognizing the shutter eyeglasses 61 to 63 by the position detecting section 17 is not limited to the image recognition utilizing the captured image taken by the camera. For example, the scheme may utilize wireless such as an infrared. In one embodiment where the wireless such as an infrared is utilized, the feature point described before may be a light source, or may be a characteristic shape, for example.

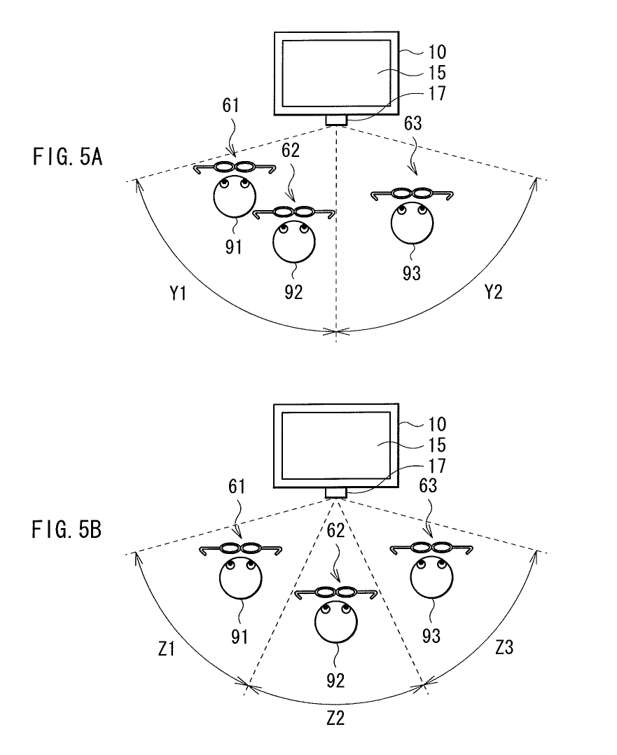

FIGS. 5A and 5B each schematically illustrate a position detecting operation of the position detecting section 17, wherein FIG. 5A illustrates an example where the number of perspectives is two, and FIG. 5B illustrates an example where the number of perspectives is three. The position detecting section 17 captures the shutter eyeglasses 61 to 63 and the observers, and recognizes, based on the feature points of the shutter eyeglasses 61 to 63, the shutter eyeglasses 61 to 63. Then, the position detecting section 17 detects which region of predetermined regions the shutter eyeglasses 61 to 63 are each located in. That is, the position detecting section 17 establishes the plurality of regions which center the display section 15, and determines one region, to which each of the shutter eyeglasses 61 to 63 belongs, from the plurality of regions. More specifically, in the example where the number of perspectives is two, the position detecting section 17 detects which region between regions Y1 and Y2 the shutter eyeglasses 61 to 63 are each located in. In the example where the number of perspectives is three, the position detecting section 17 detects which region among regions Z1 to Z3 the shutter eyeglasses 61 to 63 are each located in. Then, the position detecting section 17 supplies a result of the detection to the shutter eyeglasses controlling section 16.

With this configuration, in the display device 10, the position detecting section 17 detects respective positions (the regions Y1 and Y2 or the regions Z1 to Z3) of the shutter eyeglasses 61 to 63. Then, the shutter eyeglasses controlling section 16 selects, for each of the shutter eyeglasses 61 to 63, a stereoscopic vision image that corresponds to a position of the shutter eyeglasses 61, 62, or 63 from the stereoscopic vision images corresponding to the plural number of perspectives, and so controls the shutter eyeglasses 61 to 63 that the observers 91 to 93 are able to see respectively the selected stereoscopic vision images with the shutter eyeglasses 61 to 63. For example, in the example of the two perspectives, the shutter eyeglasses controlling section 16 so controls the shutter eyeglasses 61 that the observer 91 wearing the shutter eyeglasses 61 is able to observe the stereoscopic vision image P1 that corresponds to the region Y1, when the position detecting section 17 has detected that the shutter eyeglasses 61 is located in the region Y1. In the example of the three perspectives, the shutter eyeglasses controlling section 16 so controls the shutter eyeglasses 61 that the observer 91 wearing the shutter eyeglasses 61 is able to observe the stereoscopic vision image Q3 that corresponds to the region Z3, when the position detecting section 17 has detected that the shutter eyeglasses 61 is located in the region Z3, for example.

In one embodiment, the display device 10 is an illustrative example of a “stereoscopic display device”. The position detecting section 17 is an illustrative example of a “detecting section”. The display driving section 14 is an illustrative example of a “display controlling section”. The shutter eyeglasses controlling section 16 is an illustrative example of a “shutter controlling section”. The stereoscopic vision image generating section 13 is an illustrative example of an “image generating section”. Each of the regions Y1, Y2, and Z1 to Z3 is an illustrative example of a “perspective azimuth zone”. The image decoding section 12 is an illustrative example of a “decoder”.

### (Operation and Action)

An operation and action of the display system 1 according to the first embodiment will now be described.

### (Overview of Overall Operation)

The tuner 11 performs a process such as the predetermined receiving process on the broadcast wave received by the antenna 19 to thereby restore and generate signals such as the picture signal S and the audio signal, and then supplies the picture signal S to the image decoding section 12. The image decoding section 12 decodes the picture signal S supplied from the tuner 11, and reconstructs and generates the four parallax images A to D. The stereoscopic vision image generating section 13 generates, based on the four parallax images A to D supplied from the image decoding section 12 and on the determined number of perspectives, the stereoscopic vision images corresponding to the plural number of perspectives. The display driving section 14 controls, based on the signal which includes the stereoscopic vision images corresponding to the plural number of perspectives that are supplied from the stereoscopic vision image generating section 13, the display section 15 and the shutter eyeglasses controlling section 16. The display section 15 time-divisionally displays, based on the drive signal supplied from the display driving section 14, the stereoscopic vision images. The shutter eyeglasses controlling section 16 controls, based on the control signals supplied from the display driving section 14 and the position detecting section 17, the shutter eyeglasses 61 to 63. The shutter eyeglasses 61 to 63 operate, based on the shutter control signals CTL1 to CTL3 supplied from the shutter eyeglasses controlling section 16, each of the left-eye shutters 61L to 63L and the right-eye shutters 61R to 63R to be open and closed. The position detecting section 17 detects the relative positional relationships between the display section 15 and the shutter eyeglasses 61 to 63.

In the following, a detailed operation of the display system 1 will be described with reference to some examples.

### (Example of Detailed Operation in Two Perspectives)

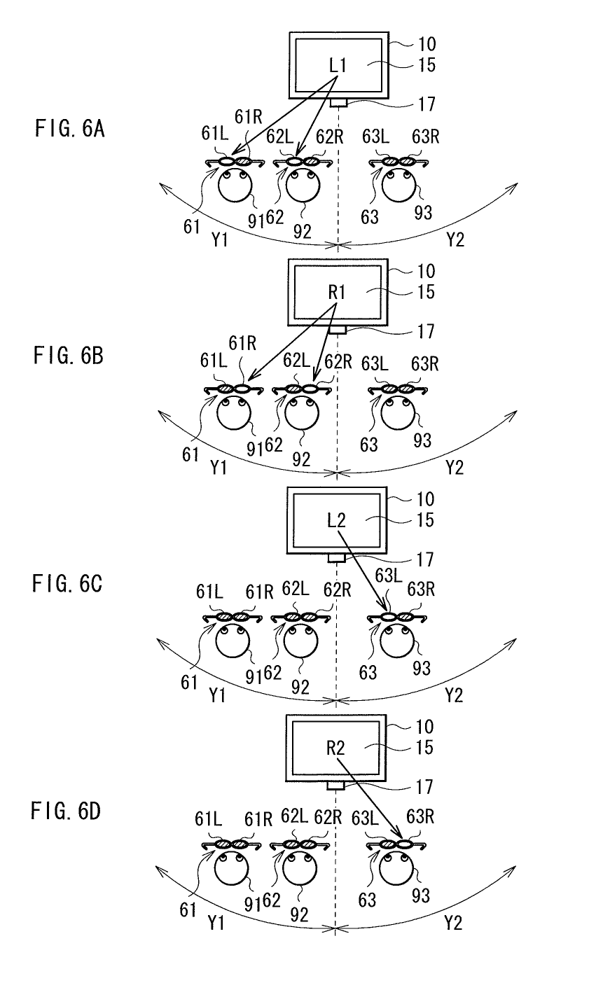

FIGS. 6A to 6D each illustrate an operation example of the display system 1 when displaying the stereoscopic vision images P1 and P2 which are two in the number of perspectives. FIG. 6A illustrates an operation in displaying the left-eye image L1 of the stereoscopic vision image P1, whereas FIG. 6B illustrates an operation in displaying the right-eye image R1 of the stereoscopic vision image P1. FIG. 6C illustrates an operation in displaying the left-eye image L2 of the stereoscopic vision image P2, whereas FIG. 6D illustrates an operation in displaying the right-eye image R2 of the stereoscopic vision image P2. In this example, two persons (i.e., the observers 91 and 92) among the three observers 91 to 93 observe the display device 10 from the region Y1, and one person (i.e., the observer 93) observes the display device 10 from the region Y2.

As illustrated in FIGS. 6A and 6B, when the display device 10 displays the stereoscopic vision image P1 (the left-eye image L1 and the right-eye image R1), the display device 10 so controls the shutter eyeglasses 61 and 62, which are in the region Y1 that corresponds to the stereoscopic vision image P1, as to open and close the shutters thereof, and so controls the shutter eyeglasses 63, which are not in the region Y1, as to close the shutters thereof.

In the shutter eyeglasses 61 and 62, the left-eye shutters 61L and 62L are open and the right-eye shutters 61R and 62R are closed as illustrated in FIG. 6A, when the display device 10 displays the left-eye image L1 of the stereoscopic vision image P1. At this time, each of the observers 91 and 92 sees the left-eye image L1 of the stereoscopic vision image P1 with his/her left eye. When the display device 10 displays the right-eye image R1 of the stereoscopic vision image P1, the left-eye shutters 61L and 62L are closed and the right-eye shutters 61R and 62R are open in the shutter eyeglasses 61 and 62, as illustrated in FIG. 6B. At this time, each of the observers 91 and 92 sees the right-eye image R1 of the stereoscopic vision image P1 with his/her right eye. Thus, each of the observers 91 and 92 sees the left-eye image L1 and the right-eye image R1 that have parallax with respect to each other with his/her eyes, and thereby experiences those images as a stereoscopic image having a depth.

Then, when the display device 10 displays the stereoscopic vision image P2 (the left-eye image L2 and the right-eye image R2), the display device 10 so controls the shutter eyeglasses 63, which are in the region Y2 that corresponds to the stereoscopic vision image P2, as to open and close the shutters thereof, and so controls the shutter eyeglasses 61 and 62, which are not in the region Y2, as to close the shutters thereof, as illustrated in FIGS. 6C and 6D.

Here, the shutter eyeglasses 63 operate in the same fashion as the operations of the shutter eyeglasses 61 and 62 for the stereoscopic vision image P1 described above (FIGS. 6A and 6B). Namely, in the shutter eyeglasses 63, the left-eye shutter 63L is open and the right-eye shutter 63R is closed as illustrated in FIG. 6C, when the display device 10 displays the left-eye image L2 of the stereoscopic vision image P2. At this time, observer 93 sees the left-eye image L2 of the stereoscopic vision image P2 with his/her left eye. When the display device 10 displays the right-eye image R2 of the stereoscopic vision image P2, the left-eye shutter 63L is closed and the right-eye shutter 63R is open in the shutter eyeglasses 63, as illustrated in FIG. 6D. At this time, the observer 93 sees the right-eye image R2 of the stereoscopic vision image P2 with his/her right eye. Thus, the observer 93 sees the left-eye image L2 and the right-eye image R2 that have parallax with respect to each other with his/her eyes, and thereby experiences those images as a stereoscopic image having a depth.

The display system 1 repeats the operations illustrated in FIGS. 6A to 6D. This thereby makes it possible for the observers 91 and 92 to each recognize a picture configured of a series of stereoscopic vision images P1 (the left-eye image L1 and the right-eye image R1) as a stereoscopic picture having a depth, and for the observer 93 to recognize a picture configured of a series of stereoscopic vision images P2 (the left-eye image L2 and the right-eye image R2) as a stereoscopic picture having a depth.

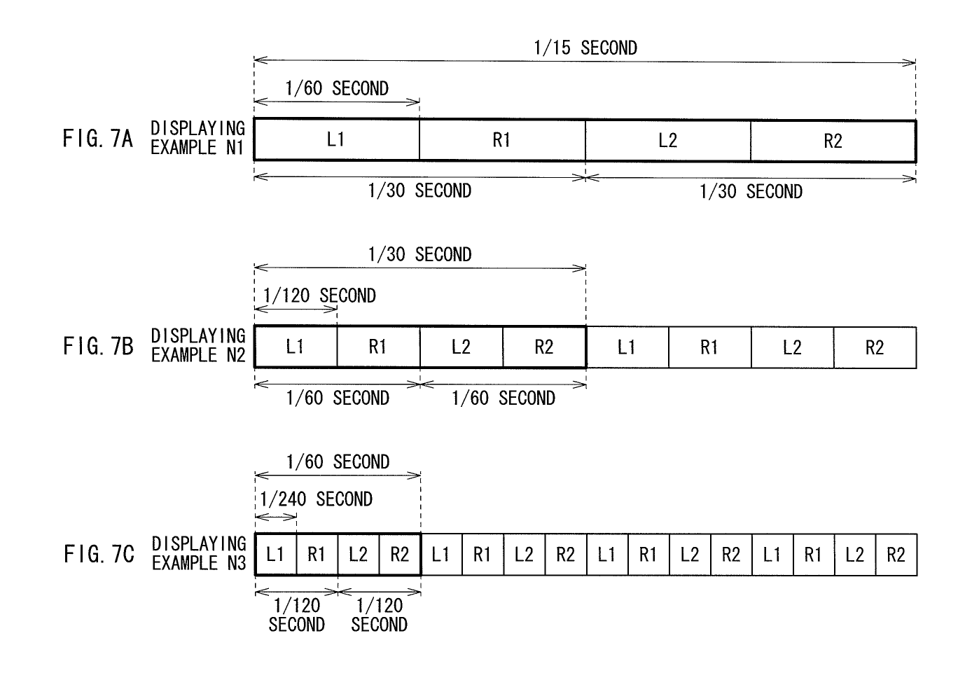

FIGS. 7A to 7C each illustrate a displaying example of the stereoscopic vision images on the display device 10, wherein FIG. 7A illustrates an example where the displaying time of each of the images is 1/60 second, FIG. 7B illustrates an example where the displaying time of each of the images is 1/120 second, and FIG. 7C illustrates an example where the displaying time of each of the images is 1/240 second.

In the example where the displaying time of each of the images is set to 1/60 second (a displaying example N1), the display device 10 rewrites the stereoscopic vision image at a frequency of once in 1/15 second (equals to 4× 1/60 second), as illustrated in FIG. 7A. In this example, each of the observers observes the left-eye image and the right-eye image during a time period of 1/30 second (equals to 2× 1/60 second), and then observes the subsequent left-eye and the right-eye images following a black-image state performed during a time period of 1/30 second (equals to 2× 1/60 second). More specifically, the observer 91 first observes the left-eye image L1 and the right-eye image R1 respectively through the left-eye shutter 61L and the right-eye shutter 61R during the time period of 1/30 second, for example. Then, the left-eye shutter 61L and the right-eye shutter 61R are both closed (the black-image state) during the subsequent time period of 1/30 second, following which the observer 91 observes the subsequent left-eye image and the right-eye image.

In the example where the displaying time of each of the images is set to 1/120 second (a displaying example N2), the display device 10 rewrites the stereoscopic vision image at a frequency of once in 1/30 second (equals to 4× 1/120 second), as illustrated in FIG. 7B. In this example, each of the observers observes the left-eye image and the right-eye image during a time period of 1/60 second (equals to 2× 1/120 second), and then observes the subsequent left-eye and the right-eye images following the black-image state performed during a time period of 1/60 second (equals to 2× 1/120 second).

In the example where the displaying time of each of the images is set to 1/240 second (a displaying example N3), the display device 10 rewrites the stereoscopic vision image at a frequency of once in 1/60 second (equals to 4× 1/240 second), as illustrated in FIG. 7C. In this example, each of the observers observes the left-eye image and the right-eye image during a time period of 1/120 second (equals to 2× 1/240 second), and then observes the subsequent left-eye and the right-eye images following the black-image state performed during a time period of 1/120 second (equals to 2× 1/240 second).

The displaying example N3 is preferable, in that the time period during which the black-image state continues is short and thus the observers are less likely to experience flickers. It is to be noted that the operation of the display device 10 is not limited to the displaying example N3 described above. For example, within an extent not affecting an image quality, a condition in which the frequency of rewriting the image (i.e., a refresh rate) is low such as the displaying example N2 may be used, or a condition in which the refresh rate is high may be used. Further, the display device 10 may include a function of adjusting the refresh rate, for example.

### (Example of Detailed Operation in Three Perspectives)

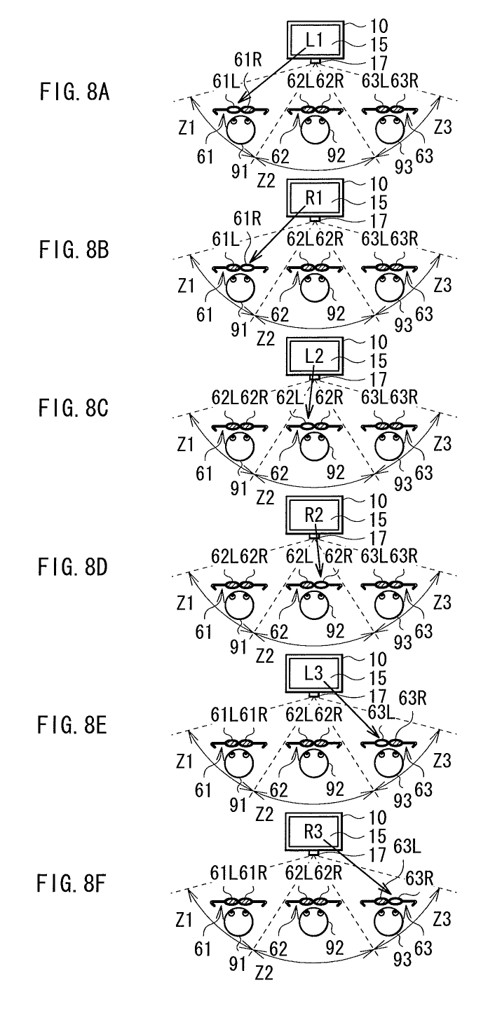

FIGS. 8A to 8F each illustrate an operation example of the display system 1 when displaying the stereoscopic vision images Q1 to Q3 which are three in the number of perspectives. FIG. 8A illustrates an operation in displaying the left-eye image L1 of the stereoscopic vision image Q1, whereas FIG. 8B illustrates an operation in displaying the right-eye image R1 of the stereoscopic vision image Q1. FIG. 8C illustrates an operation in displaying the left-eye image L2 of the stereoscopic vision image Q2, whereas FIG. 8D illustrates an operation in displaying the right-eye image R2 of the stereoscopic vision image Q2. FIG. 8E illustrates an operation in displaying the left-eye image L3 of the stereoscopic vision image Q3, whereas FIG. 8F illustrates an operation in displaying the right-eye image R3 of the stereoscopic vision image Q3. In this example, the observer observes the display device 10 from the region Z1, the observer 92 observes the display device 10 from the region Z2, and the observer 93 observes the display device 10 from the region Z3.

As illustrated in FIGS. 8A and 8B, when the display device 10 displays the stereoscopic vision image Q1 (the left-eye image L1 and the right-eye image R1), the display device so controls the shutter eyeglasses 61, which are in the region Z1 that corresponds to the stereoscopic vision image Q1, as to open and close the shutters thereof, and so controls the shutter eyeglasses 62 and 63, which are not in the region Z1, as to close the shutters thereof. Thus, the observer 91 sees the left-eye image L1 and the right-eye image R1 that have parallax with respect to each other with his/her eyes, and thereby experiences those images as a stereoscopic image having a depth.

Then, when the display device 10 displays the stereoscopic vision image Q2 (the left-eye image L2 and the right-eye image R2), the display device 10 so controls the shutter eyeglasses 62, which are in the region Z2 that corresponds to the stereoscopic vision image Q2, as to open and close the shutters thereof, and so controls the shutter eyeglasses 61 and 63, which are not in the region Z2, as to close the shutters thereof, as illustrated in FIGS. 8C and 8D. Thus, the observer 92 sees the left-eye image L2 and the right-eye image R2 that have parallax with respect to each other with his/her eyes, and thereby experiences those images as a stereoscopic image having a depth.

Further, when the display device 10 displays the stereoscopic vision image Q3 (the left-eye image L3 and the right-eye image R3), the display device 10 so controls the shutter eyeglasses 63, which are in the region Z3 that corresponds to the stereoscopic vision image Q3, as to open and close the shutters thereof, and so controls the shutter eyeglasses 61 and 62, which are not in the region Z3, as to close the shutters thereof, as illustrated in FIGS. 8E and 8F. Thus, the observer 93 sees the left-eye image L3 and the right-eye image R3 that have parallax with respect to each other with his/her eyes, and thereby experiences those images as a stereoscopic image having a depth.

The display system 1 repeats the operations illustrated in FIGS. 8A to 8F. This thereby makes it possible for the observer 91 to recognize a picture configured of a series of stereoscopic vision images Q1 (the left-eye image L1 and the right-eye image R1) as a stereoscopic picture having a depth, for the observer 92 to recognize a picture configured of a series of stereoscopic vision images Q2 (the left-eye image L2 and the right-eye image R2) as a stereoscopic picture having a depth, and for the observer 93 to recognize a picture configured of a series of stereoscopic vision images Q3 (the left-eye image L3 and the right-eye image R3) as a stereoscopic picture having a depth.

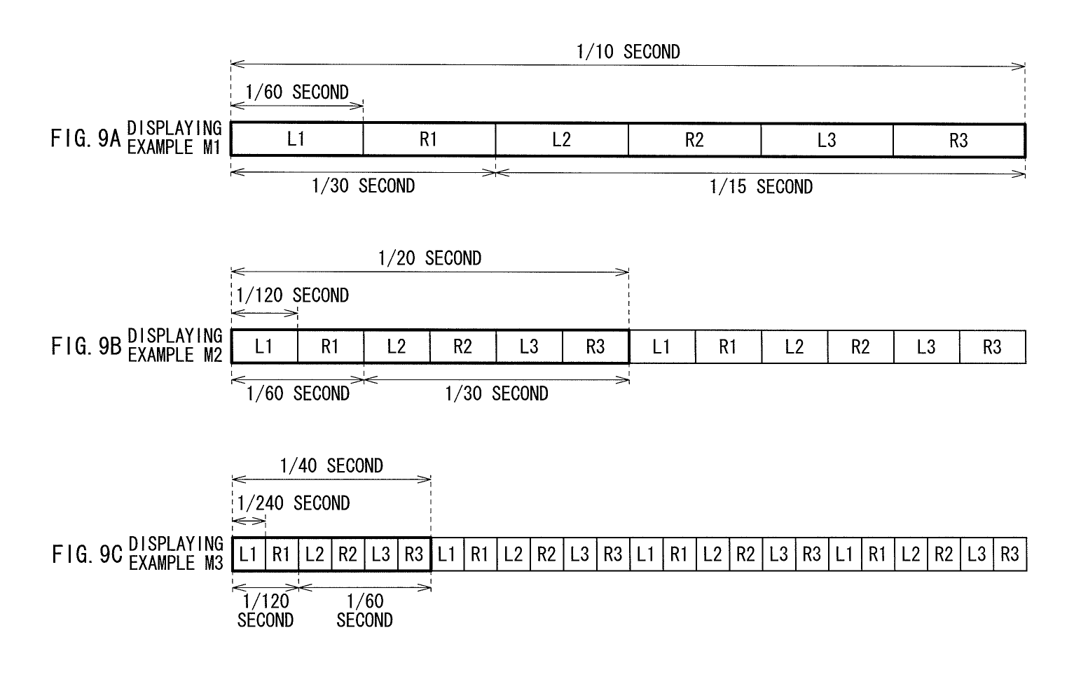

FIGS. 9A to 9C each illustrate a displaying example of the stereoscopic vision images on the display device 10, wherein FIG. 9A illustrates an example where the displaying time of each of the images is 1/60 second, FIG. 9B illustrates an example where the displaying time of each of the images is 1/120 second, and FIG. 9C illustrates an example where the displaying time of each of the images is 1/240 second.

In the example where the displaying time of each of the images is set to 1/60 second (a displaying example M1), the display device 10 rewrites the stereoscopic vision image at a frequency of once in 1/10 second (equals to 6× 1/60 second), as illustrated in FIG. 9A. In this example, each of the observers observes the left-eye image and the right-eye image during a time period of 1/30 second (equals to 2× 1/60 second), and then observes the subsequent left-eye and the right-eye images following the black-image state performed during a time period of 1/15 second (equals to 4× 1/60 second).

In the example where the displaying time of each of the images is set to 1/120 second (a displaying example M2), the display device 10 rewrites the stereoscopic vision image at a frequency of once in 1/20 second (equals to 6× 1/120 second), as illustrated in FIG. 9B. In this example, each of the observers observes the left-eye image and the right-eye image during a time period of 1/60 second (equals to 2× 1/120 second), and then observes the subsequent left-eye and the right-eye images following the black-image state performed during a time period of 1/30 second (equals to 4× 1/120 second).

In the example where the displaying time of each of the images is set to 1/240 second (a displaying example M3), the display device 10 rewrites the stereoscopic vision image at a frequency of once in 1/40 second (equals to 6× 1/240 second), as illustrated in FIG. 9C. In this example, each of the observers observes the left-eye image and the right-eye image during a time period of 1/120 second (equals to 2× 1/240 second), and then observes the subsequent left-eye and the right-eye images following the black-image state performed during a time period of 1/60 second (equals to 4× 1/240 second).

As in the example of the two perspectives, the displaying example M3 is preferable, in that the time period during which the black-image state continues is short and thus the observers are less likely to experience the flickers. It is to be noted that the operation of the display device 10 is not limited to the displaying example M3 described above. For example, within an extent not affecting the image quality, a condition in which the refresh rate is low such as the displaying example M2 may be used, or a condition in which the refresh rate is high may be used. Further, the display device 10 may include a function of adjusting the refresh rate, for example. Also, the display device 10 may switch over the refresh rate according to the determined number of perspectives. For example, the display device 10 may increase the refresh rate when the number of perspectives is large, and may decrease the refresh rate when the number of perspectives is small.

FIGS. 8A to 8F each illustrate the example where the observers 91 to 93 observe the display device 10 respectively from the different regions Z1 to Z3, although it is not limited thereto. For example, the plurality of observers may observe the display device 10 from one region, as described below.

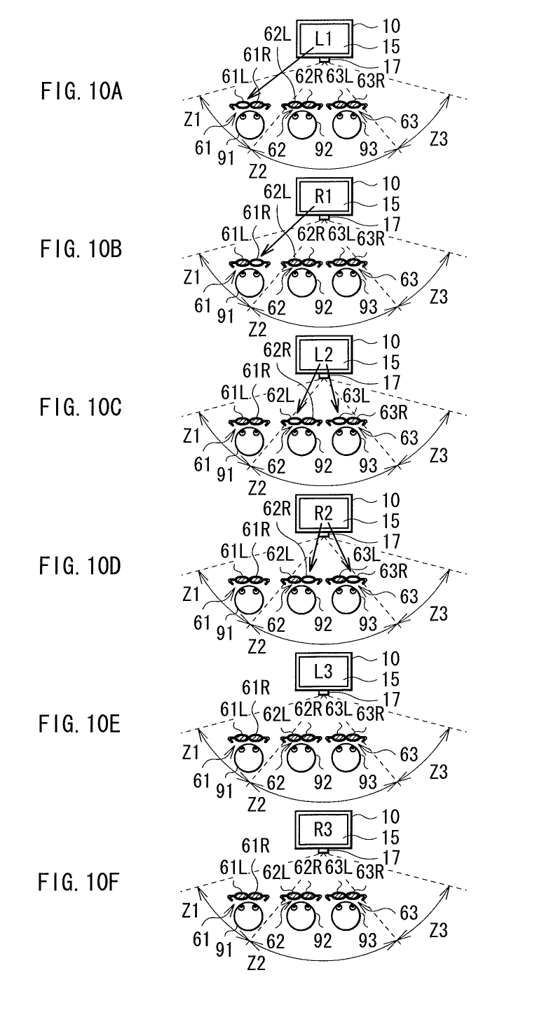

FIGS. 10A to 10F each illustrate an operation example of the display system 1 when displaying the stereoscopic vision images Q1 to Q3 which are three in the number of perspectives. FIG. 10A illustrates an operation in displaying the left-eye image L1 of the stereoscopic vision image Q1, whereas FIG. 10B illustrates an operation in displaying the right-eye image R1 of the stereoscopic vision image Q1. FIG. 10C illustrates an operation in displaying the left-eye image L2 of the stereoscopic vision image Q2, whereas FIG. 10D illustrates an operation in displaying the right-eye image R2 of the stereoscopic vision image Q2. FIG. 10E illustrates an operation in displaying the left-eye image L3 of the stereoscopic vision image Q3, whereas FIG. 10F illustrates an operation in displaying the right-eye image R3 of the stereoscopic vision image Q3. In this example, the observer 91 observes the display device 10 from the region Z1, and the observers 92 and 93 observe the display device 10 from the region Z2. In other words, in this example, there is no observer in the region Z3.

As illustrated in FIGS. 10A and 10B, when the display device 10 displays the stereoscopic vision image Q1 (the left-eye image L1 and the right-eye image R1), the display device 10 so controls the shutter eyeglasses 61, which are in the region Z1 that corresponds to the stereoscopic vision image Q1, as to open and close the shutters thereof, and so controls the shutter eyeglasses 62 and 63, which are not in the region Z1, as to close the shutters thereof. Thus, the observer 91 sees the left-eye image L1 and the right-eye image R1 that have parallax with respect to each other with his/her eyes, and thereby experiences those images as a stereoscopic image having a depth.

Then, when the display device 10 displays the stereoscopic vision image Q2 (the left-eye image L2 and the right-eye image R2), the display device 10 so controls the shutter eyeglasses 62 and 63, which are in the region Z2 that corresponds to the stereoscopic vision image Q2, as to open and close the shutters thereof, and so controls the shutter eyeglasses 61, which are not in the region Z2, as to close the shutters thereof, as illustrated in FIGS. 10C and 10D. Thus, each of the observers 92 and 93 sees the left-eye image L2 and the right-eye image R2 that have parallax with respect to each other with his/her eyes, and thereby experiences those images as a stereoscopic image having a depth.

Further, when the display device 10 displays the stereoscopic vision image Q3 (the left-eye image L3 and the right-eye image R3), the display device 10 so controls the shutter eyeglasses 61 to 63, which are not in the region Z3, as to close the shutters thereof, as illustrated in FIGS. 10E and 10F.

The display system 1 repeats the operations illustrated in FIGS. 10A to 10F. This thereby makes it possible for the observer 91 to recognize a picture configured of a series of stereoscopic vision images Q1 (the left-eye image L1 and the right-eye image R1) as a stereoscopic picture having a depth, and for each of the observers 92 and 93 to recognize a picture configured of a series of stereoscopic vision images Q2 (the left-eye image L2 and the right-eye image R2) as a stereoscopic picture having a depth.

### (Effect)

According to the first embodiment described in the foregoing, the stereoscopic vision images corresponding to the plural number of perspectives are generated in advance, and the shutters of the shutter eyeglasses are controlled to be open and closed in accordance with the azimuth of the shutter eyeglasses detected by the position detecting section 17. Therefore, it is possible to display the stereoscopic vision image that corresponds to the position of the perspective of the observer with a simple configuration.

Also, in the first embodiment, the position detecting section 17 detects the azimuths of the plurality of shutter eyeglasses, and the shutter eyeglasses controlling section 16 controls the shutters of the plurality of shutter eyeglasses to be open and closed. Therefore, it is possible to display the stereoscopic vision images that correspond to the positions of the perspectives of the observers even there are plurality of observers.

In the embodiment described above, the position detecting section 17 recognizes the shutter eyeglasses based on the feature point of the shutter eyeglasses, although it is not limited thereto. In an alternative embodiment, the observer wearing the shutter eyeglasses himself/herself may be detected, for example. In the alternative embodiment, a body of the observer, such as a face and an eye of the observer, may be recognized, for example.

### 2. Second Embodiment

Hereinafter, a display system 2 according to a second embodiment of the technology will be described. The second embodiment has a configuration similar to that of the first embodiment described above (FIG. 1. etc.), except that a method of generating, based on the four parallax images A to D, the stereoscopic vision images corresponding to the three perspectives in the stereoscopic vision image generating section differs from that according to the first embodiment. Namely, the second embodiment configures a display device 20 and the display system 2 using a stereoscopic vision image generating section 23 that generates, with the method different from that of the first embodiment described above, the stereoscopic vision images corresponding to the three perspectives. Note that the same or equivalent elements as those of the display system 1 according to the first embodiment described above are denoted with the same reference numerals, and will not be described in detail.

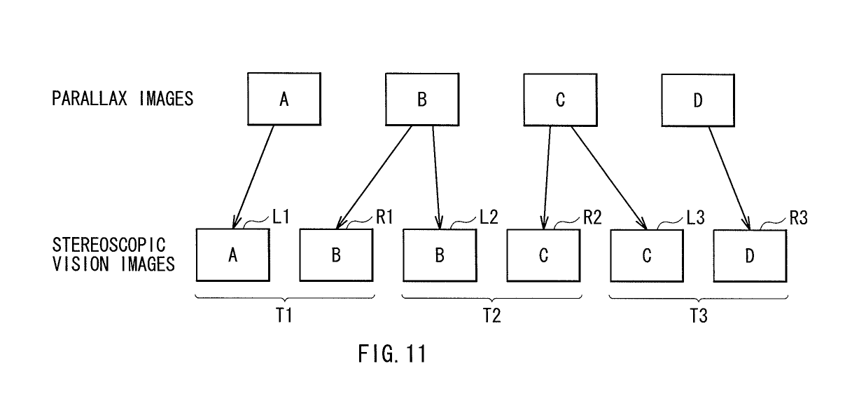

FIG. 11 schematically illustrates an operation of the stereoscopic vision image generating section 23 when the number of perspectives is three. The stereoscopic vision image generating section 23 generates, based on the parallax images A and B, a stereoscopic vision image T1, generates, based on the parallax images B and C, a stereoscopic vision image T2, and generates, based on the parallax images C and D, a stereoscopic vision image T3. More specifically, in generating the stereoscopic vision image T1, the stereoscopic vision image generating section 23 uses the parallax image A directly or “as it is” to generate the left-eye image L1, and uses the parallax image B directly or “as it is” to generate the right-eye image R1. In generating the stereoscopic vision image T2, the stereoscopic vision image generating section 23 uses the parallax image B directly or “as it is” to generate the left-eye image L2, and uses the parallax image C directly or “as it is” to generate the right-eye image R2. Further, in generating the stereoscopic vision image T3, the stereoscopic vision image generating section 23 uses the parallax image C directly or “as it is” to generate the left-eye image L3, and uses the parallax image D directly or “as it is” to generate the right-eye image R3.

Thereby, the stereoscopic vision image T1 serves as an image when viewing the object from the perspective on the left side of the object, and the stereoscopic vision image T2 serves as an image when viewing the object from the front perspective. The stereoscopic vision image T3 serves as an image when viewing the object from the perspective on the right side of the object.

Note that an operation of the stereoscopic vision image generating section 23 when the number of perspectives is two is similar to that of the stereoscopic vision image generating section 13 according to the first embodiment described above (FIG. 4A).

In this embodiment, some of the parallax images A to D are used, in the stereoscopic vision image generating section 23, for generating different stereoscopic vision images. Namely, as illustrated in FIG. 11, the parallax image B is used for generating both the stereoscopic vision images T1 and T2, and the parallax image C is used for generating both the stereoscopic vision images T2 and T3. In other words, the right-eye image R1 of the stereoscopic vision image T1 and the left-eye image L2 of the stereoscopic vision image T2 are the same, and the right-eye image R2 of the stereoscopic vision image T2 and the left-eye image L3 of the stereoscopic vision image T3 are the same. That is, the stereoscopic vision image generating section 23 generates the stereoscopic vision images corresponding to the plurality of perspectives to allow a common parallax image to be included in a couple of stereoscopic vision images corresponding to a couple of adjacent perspectives.

Also, unlike the first embodiment described above, each of the left-eye image and the right-eye image of the respective stereoscopic vision images is generated using any one of the parallax images A to D directly or “as it is” in the stereoscopic vision image generating section 23. In other words, although the stereoscopic vision image generating section 13 according to the first embodiment described above performs the predetermined parallax generating process, the stereoscopic vision image generating section 23 according to the second embodiment does not perform the predetermined parallax generating process. Thus, the second embodiment makes it possible to reduce a load in operation, and to lower performance desired for a circuit.

In one embodiment, the display device 20 is an illustrative example of a “stereoscopic display device”. The stereoscopic vision image generating section 23 is an illustrative example of an “image generating section”.

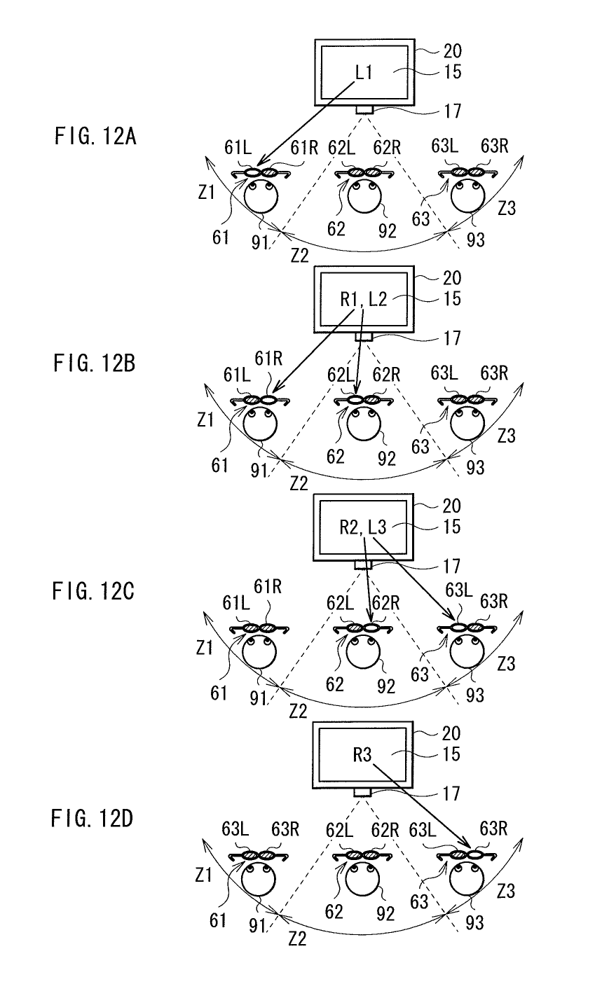

FIGS. 12A to 12D each illustrate an operation example of the display system 2 when displaying the stereoscopic vision images T1 to T3 which are three in the number of perspectives. FIG. 12A illustrates an operation in displaying the left-eye image L1 of the stereoscopic vision image T1, whereas FIG. 12B illustrates an operation in displaying the right-eye image R1 of the stereoscopic vision image T1 and the left-eye image L2 of the stereoscopic vision image T2. FIG. 12C illustrates an operation in displaying the right-eye image R2 of the stereoscopic vision image T2 and the left-eye image L3 of the stereoscopic vision image T3, whereas FIG. 12D illustrates an operation in displaying the right-eye image R3 of the stereoscopic vision image T3. In this example, the observer 91 observes the display device 20 from the region Z1, the observer 92 observes the display device 20 from the region Z2, and the observer 93 observes the display device 20 from the region Z3.

As illustrated in FIG. 12A, when the display device 20 displays the left-eye image L1 of the stereoscopic vision image T1, the display device 20 so controls the shutter eyeglasses 61, which are in the region Z1 that corresponds to the stereoscopic vision image T1, as to open the left-eye shutter 61L, and so controls the shutter eyeglasses 62 and 63, which are not in the region Z1, as to close the shutters thereof.

Then, when the display device 20 displays the right-eye image R1 of the stereoscopic vision image T1 and the left-eye image L2 of the stereoscopic vision image T2, the display device 20 so controls the shutter eyeglasses 61, which are in the region Z1 that corresponds to the stereoscopic vision image T1, as to open the right-eye shutter 61R, so controls the shutter eyeglasses 62, which are in the region Z2 that corresponds to the stereoscopic vision image T2, as to open the left-eye shutter 62L, and so controls the shutter eyeglasses 63, which are not in the regions Z1 and Z2, as to close the shutters thereof, as illustrated in FIG. 12B.

Thus, as illustrated in FIGS. 12A and 12B, the observer 91 sees the left-eye image L1 (FIG. 12A) and the right-eye image R1 (FIG. 12B) that have parallax with respect to each other with his/her eyes, and thereby experiences those images as a stereoscopic image having a depth.

Then, when the display device 20 displays the right-eye image R2 of the stereoscopic vision image T2 and the left-eye image L3 of the stereoscopic vision image T3, the display device 20 so controls the shutter eyeglasses 62, which are in the region Z2 that corresponds to the stereoscopic vision image T2, as to open the right-eye shutter 62R, so controls the shutter eyeglasses 63, which are in the region Z3 that corresponds to the stereoscopic vision image T3, as to open the left-eye shutter 63L, and so controls the shutter eyeglasses 61, which are not in the regions Z2 and Z3, as to close the shutters thereof, as illustrated in FIG. 12C.

Thus, as illustrated in FIGS. 12B and 12C, the observer 92 sees the left-eye image L2 (FIG. 12B) and the right-eye image R2 (FIG. 12C) that have parallax with respect to each other with his/her eyes, and thereby experiences those images as a stereoscopic image having a depth.

Further, when the display device 20 displays the right-eye image R3 of the stereoscopic vision image T3, the display device 20 so controls the shutter eyeglasses 63, which are in the region Z3 that corresponds to the stereoscopic vision image T3, as to open the right-eye shutter 63R, and so controls the shutter eyeglasses 61 and 62, which are not in the region Z3, as to close the shutters thereof, as illustrated in FIG. 12D.

Thus, as illustrated in FIGS. 12C and 12D, the observer 93 sees the left-eye image L3 (FIG. 12C) and the right-eye image R3 (FIG. 12D) that have parallax with respect to each other with his/her eyes, and thereby experiences those images as a stereoscopic image having a depth.

The display system 2 repeats the operations illustrated in FIGS. 12A to 12D. This thereby makes it possible for the observer 91 to recognize a picture configured of a series of stereoscopic vision images T1 (the left-eye image L1 and the right-eye image R1) as a stereoscopic picture having a depth, for the observer 92 to recognize a picture configured of a series of stereoscopic vision images T2 (the left-eye image L2 and the right-eye image R2) as a stereoscopic picture having a depth, and for the observer 93 to recognize a picture configured of a series of stereoscopic vision images T3 (the left-eye image L3 and the right-eye image R3) as a stereoscopic picture having a depth.

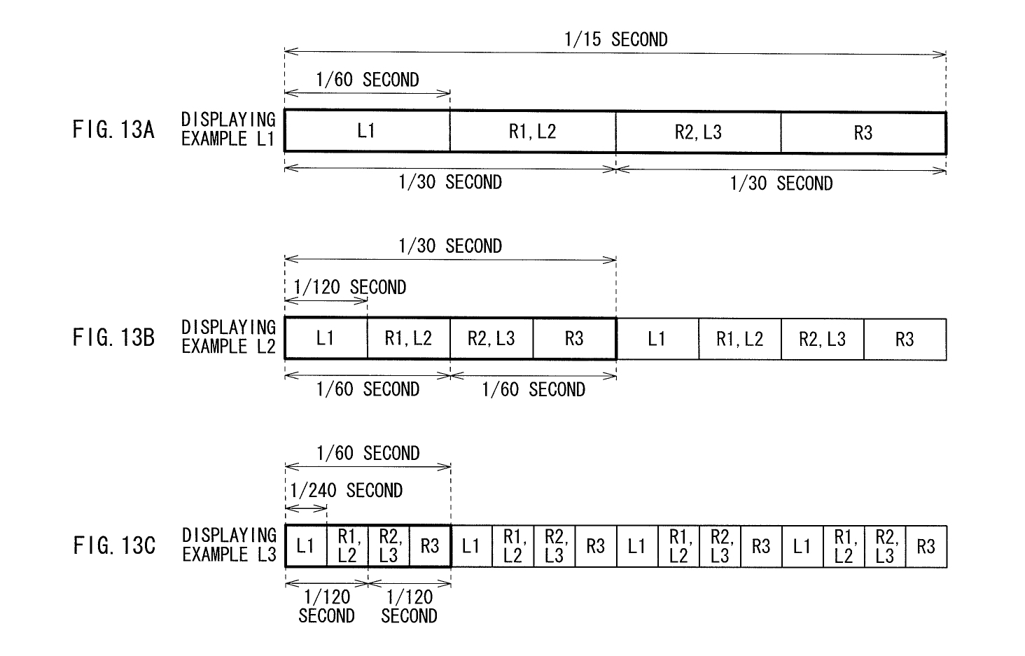

FIGS. 13A to 13C each illustrate a displaying example of the stereoscopic vision images on the display device 20, wherein FIG. 13A illustrates an example where the displaying time of each of the images is 1/60 second, FIG. 13B illustrates an example where the displaying time of each of the images is 1/120 second, and FIG. 13C illustrates an example where the displaying time of each of the images is 1/240 second.

In the example where the displaying time of each of the images is set to 1/60 second (a displaying example L1), the display device 20 rewrites the stereoscopic vision image at a frequency of once in 1/15 second (equals to 4× 1/60 second), as illustrated in FIG. 13A. In this example, each of the observers observes the left-eye image and the right-eye image during a time period of 1/30 second (equals to 2× 1/60 second), and then observes the subsequent left-eye and the right-eye images following the black-image state performed during a time period of 1/30 second (equals to 2× 1/60 second).

In the example where the displaying time of each of the images is set to 1/120 second (a displaying example L2), the display device 20 rewrites the stereoscopic vision image at a frequency of once in 1/30 second (equals to 4× 1/120 second), as illustrated in FIG. 13B. In this example, each of the observers observes the left-eye image and the right-eye image during a time period of 1/60 second (equals to 2× 1/120 second), and then observes the subsequent left-eye and the right-eye images following the black-image state performed during a time period of 1/60 second (equals to 2× 1/120 second).

In the example where the displaying time of each of the images is set to 1/240 second (a displaying example L3), the display device 20 rewrites the stereoscopic vision image at a frequency of once in 1/60 second (equals to 4× 1/240 second), as illustrated in FIG. 13C. In this example, each of the observers observes the left-eye image and the right-eye image during a time period of 1/120 second (equals to 2× 1/240 second), and then observes the subsequent left-eye and the right-eye images following the black-image state performed during a time period of 1/120 second (equals to 2× 1/240 second).

The displaying example L3 is preferable, in that the time period during which the black-image state continues is short and thus the observers are less likely to experience the flickers. It is to be noted that the operation of the display device 20 is not limited to the displaying example L3 described above. For example, within an extent not affecting the image quality, a condition in which the refresh rate is low such as the displaying example L2 may be used, or a condition in which the refresh rate is high may be used.

The refresh rate in the displaying example L3 according to the second embodiment is higher than that in the displaying example M3 (FIG. 9C) according to the first embodiment described above. One reason is that the display device 10 according to the first embodiment time-divisionally displays the six images of L1, R1, L2, R2, L3, and R3 as illustrated in FIGS. 8A to 8F, whereas the display device 20 according to the second embodiment time-divisionally displays the four images of L1, (R1, L2), (R2, L3), and R3 as illustrated in FIGS. 12A to 12D. In other words, one reason is that the parallax image B is shared by the right-eye image R1 of the stereoscopic vision image T1 and the left-eye image L2 of the stereoscopic vision image T2, and the parallax image C is shared by the right-eye image R2 of the stereoscopic vision image T2 and the left-eye image L3 of the stereoscopic vision image T3. Thus, the second embodiment is capable of increasing the refresh rate. Therefore, it is possible to further reduce a possibility that the observers experience the flickers.

According to the second embodiment, the parallax image B is shared by the right-eye image R1 of the stereoscopic vision image T1 and the left-eye image L2 of the stereoscopic vision image T2, and the parallax image C is shared by the right-eye image R2 of the stereoscopic vision image T2 and the left-eye image L3 of the stereoscopic vision image T3. Therefore, it is possible to increase the refresh rate when the display device performs the displaying.

In the second embodiment, the stereoscopic vision image generating section does not perform the parallax generating process. Therefore, it is possible to reduce a load in operation, and to lower performance desired for a circuit.

Other effects achieved by the second embodiment are similar to those according to the first embodiment described above.

Although the technology has been described in the foregoing by way of example with reference to the embodiments, the technology is not limited thereto but may be modified in a wide variety of ways.

For example, in the embodiments described above, four parallax images are obtained by receiving the broadcast wave, although it is not limited thereto. Alternatively, the parallax images may be supplied from other picture source such as a picture reproduction device.

For example, in the embodiments described above, the stereoscopic vision image generating section generates the stereoscopic vision images corresponding to three perspectives, although it is not limited thereto. Alternatively, the stereoscopic vision images may be directly obtained from a picture source that supplies the stereoscopic vision images corresponding to three perspectives, for example.

For example, in the embodiments described above, the stereoscopic vision image generating section generates, from the four parallax images, the stereoscopic vision images corresponding to three perspectives, although it is not limited thereto. In one embodiment, the stereoscopic vision images corresponding to three perspectives may be generated from parallax images which are five or more in number, or may be generated from parallax images which are three or less in number. In one embodiment, the stereoscopic vision images corresponding to four or more perspectives or two or less perspectives may be generated from the four parallax images.

For example, in the embodiments described above, the number of perspectives determined or set is two or three, although it is not limited thereto. Alternatively, the number of perspectives may be four or more, for example.

For example, in the embodiments described above, three shutter eyeglasses are used, although it is not limited thereto. Alternatively, two or less shutter eyeglasses, or four or more shutter eyeglasses may be used.

Although the technology has been described in terms of exemplary embodiments, it is not limited thereto. It should be appreciated that variations may be made in the described embodiments by persons skilled in the art without departing from the scope of the technology as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in this disclosure is intended to be dedicated to the public regardless of whether the element or component is explicitly recited in the following claims.

What is claimed is:

1. A stereoscopic display device, comprising:
a display section;
a detecting section detecting an azimuth or respective azimuths in which one or more shutter eyeglasses are located, the shutter eyeglasses including a left-eye shutter and a right-eye shutter;
a display controlling section time-divisionally displaying, on the display section, a plurality of stereoscopic vision images corresponding to a plurality of perspectives, through time-divisionally displaying, on the display section, a left-eye image and a right-eye image configuring each of the plurality of stereoscopic vision images corresponding to the respective perspectives; and
a shutter controlling section allowing the left-eye shutter and the right-eye shutter in one or more shutter eyeglasses located in the azimuth corresponding to the perspective of the stereoscopic vision image currently displayed on the display section to be open and closed, based on a detection result from the detecting section, and in synchronization with a left-eye-image display timing on the display section and a left-eye-image display timing on the display section for each of the stereoscopic vision images corresponding to the respective perspectives.

2. The stereoscopic display device according to claim 1, further comprising an image generating section generating the stereoscopic vision images corresponding to the plurality of perspectives.

3. The stereoscopic display device according to claim 1, wherein the detecting section establishes a plurality of perspective azimuth zones which center the display section, and determines one perspective azimuth zone, to which each of the shutter eyeglasses belongs, from the plurality of perspective azimuth zones.

4. The stereoscopic display device according to claim 3, wherein the stereoscopic vision images corresponding to the plurality of perspectives correspond to the plurality of perspective azimuth zones, respectively.

5. The stereoscopic display device according to claim 4, further comprising an image generating section generating the stereoscopic vision images corresponding to the plurality of perspectives.

6. The stereoscopic display device according to claim 2, further comprising a decoder reconstructing, based on supplied image frames, a plurality of parallax images,
wherein the image generating section generates, based on the plurality of parallax images reconstructed, the stereoscopic vision images corresponding to the plurality of perspectives.

7. The stereoscopic display device according to claim 6, wherein the plurality of parallax images forming one scene are treated to configure one image frame.

8. The stereoscopic display device according to claim 6, wherein each of the plurality of parallax images forming one scene is treated to configure one image frame.

9. The stereoscopic display device according to claim 6, wherein the plurality of parallax images forming one scene are divided into a plurality of groups, and the parallax images included in each of the groups are treated to configure one image frame.

10. The stereoscopic display device according to claim 1, wherein the detecting section includes an image-capturing section, and detects, based on an image captured by the image-capturing section, the azimuth or the respective azimuths in which one or more shutter eyeglasses are located.

11. The stereoscopic display device according to claim 10, wherein the detecting section recognizes the shutter eyeglasses based on a feature point which is provided to the shutter eyeglasses.

12. The stereoscopic display device according to claim 5, wherein the image generating section generates the stereoscopic vision images corresponding to the plurality of perspectives to allow a common parallax image to be included in a couple of stereoscopic vision images corresponding to a couple of adjacent perspectives.

13. The stereoscopic display device according to claim 12, wherein
while the common parallax image is on display, the shutter controlling section allows the left-eye shutter of the shutter eyeglasses belonging to a first perspective azimuth zone to be open and allows the right-eye shutter thereof to be closed, whereas allows the left-eye shutter of the shutter eyeglasses belonging to a second perspective azimuth zone to be closed and allows the right-eye shutter thereof to be open, the first and second perspective azimuth zones being adjacent to each other.

14. A display control circuit, comprising:
a detecting section detecting an azimuth or respective azimuths in which one or more shutter eyeglasses are located, the shutter eyeglasses including a left-eye shutter and a right-eye shutter;
a display controlling section time-divisionally displaying, on a display section, a plurality of stereoscopic vision images corresponding to a plurality of perspectives, through time-divisionally displaying, on the display section, a left-eye image and a right-eye image configuring each of the plurality of stereoscopic vision images corresponding to the respective perspectives; and
a shutter controlling section allowing the left-eye shutter and the right-eye shutter in one or more shutter eyeglasses located in the azimuth corresponding to the perspective of the stereoscopic vision image currently displayed on the display section to be open and closed, based on a detection result from the detecting section, and in synchronization with a left-eye-image display timing on the display section and a left-eye-image display timing on the display section for each of the stereoscopic vision images corresponding to the respective perspectives.

15. A display method, comprising:
time-divisionally displaying a plurality of stereoscopic vision images corresponding to a plurality of perspectives, through time-divisionally displaying a left-eye image and a right-eye image configuring each of the plurality of stereoscopic vision images corresponding to the respective perspectives;
detecting an azimuth or respective azimuths in which one or more shutter eyeglasses are located, the shutter eyeglasses including a left-eye shutter and a right-eye shutter; and
allowing the left-eye shutter and the right-eye shutter in one or more shutter eyeglasses located in the azimuth corresponding to the perspective of the stereoscopic vision image currently displayed to be open and closed, based on a detection result thereof, and in synchronization with a left-eye-image display timing and a left-eye-image display timing for each of the stereoscopic vision images corresponding to the respective perspectives.
